(19) United States
(12) Patent Application Publication
(10) Pub. No.: US 2009/0151216 A1
(43) Pub. Date: Jun. 18, 2009

(54) Human urine scent cover, elimination and neutralization of human urine scent kits and methods

(76) Inventor: Daniel L. Haggerty, Stuart, FL (US)

Correspondence Address: Daniel L. Haggerty, 601 Heritage Dr, #103, Jupiter, FL, 33458, US

(21) Appl. No.: 12/316,795

(22) Filed: Dec. 16, 2008

Related U.S. Application Data
(60) Provisional application No. 61/007,957, filed on Dec. 17, 2007.

(51) Int. Cl. A01M 31/00

(52) U.S. Cl. 43/1

(57) ABSTRACT

A semi-solid screen like wafer comprised of odor elimination and neutralization chemicals or comprised of animal urine, glands and gland secretion or comprised of natural plant scents or comprised of any combination thereof in a freeze dried state or suspended state in a gelatin material rehydratable or dissolvable in human urine designed to cover, eliminate and neutralize human urine scent in the wilderness environment and to lure and attract wildlife into the specific wilderness area.

### CROSS-REFERENCE TO RELATED APPLICATIONS

This application claims the benefit of Provisional Patent Application Ser. No. 61/007,957, filed Dec. 17, 2007 by the present Inventor.

### FEDERALLY SPONSORED RESEARCH

None.

### SEQUENCE LISTING

None.

### BACKGROUND

1. Field of Invention

This invention relates to human urine scent cover and elimination of human urine scent in a wilderness environment to lure and attract wildlife and to evade detection.

2. Prior Art

This invention relates to human urine scent cover and elimination of human urine scent in the wilderness environment to lure and attract wildlife and to evade detection. Hunters, wildlife enthusiasts and photographers all enter the wilderness environment with the objective of luring and attracting wildlife into their area while not being detected by the wildlife they seek to encounter. In order for hunters, wildlife enthusiasts and photographers to be successful in this endeavour, they must be able to blend into their environment by means of stealth, employing camouflage, scent cover, scent lures and scent elimination. Other intangible requirements are patience, intelligence, and both mental and physical endurance.

One element of physical endurance is being able to “hold your pee” in the woods. In other words, have a large bladder so you don't have to urinate in the wilderness. This is important because wildlife, especially deer, rely on their highly developed sense of smell to alert them of the presence of humans and/or danger in the area. Once wildlife smells human urine (fresh or stale) they simply leave the area.

Humans in the wilderness environment need to be conscious of the scents they emit, especially urine, if they expect to attract and encounter wildlife.

Humans to date, have dealt with their urine elimination problem in the wilderness by (a) expanding their bladder to hold their urine until such time as they are out of the wilderness, (b) bringing a container/pouch into the wilderness with them to collect and store their urine for later disposal, or (c) the least desirable means of urine elimination, go on the tree that you are standing next to. All three of the above means of urine elimination have obvious drawbacks for those who are attempting to blend into the environment undetected so as to attract and encounter wildlife. Thus, there exists an unmet need for dealing with human urine scent in the wilderness environment.

Prior art in the area of animal scent lures, attractants and scent covers have only been applied to or have attempted to cover normal human scents such as perspiration, mouth odor, foot odor and/or collection of human urine. Prior art does not attempt to or deal with the problem and/or benefit of human urine scent being emitted into the wilderness environment. In other words, humans urinating in the woods. Nor does prior art attempt to cover, eliminate or convert to an attractant/lure human urine scent that has been released in the wilderness environment.

Prior art in the area of household and commercial chemicals manufactured to eliminate and neutralize human urine scent in everyday household or commercial use have not sought to use or apply their products by conveniently packaging them for use in the wilderness environment to eliminate and neutralize human urine scent released in the wilderness environment in order for humans to evade detection by wildlife.

Nor has prior art used or applied a combination of animal scent lures, attractants and scent covers with household and commercial chemicals manufactured to eliminate and neutralize human urine scent in everyday household or commercial use to cover and eliminate human urine scent released in the wilderness environment in order to lure and attract wildlife into the specific area and to evade detection by wildlife.

As stated above, should wildlife detect human urine in the specific area, they will leave. Contrary to prior art, the present invention addresses the problem of humans urinating in the wilderness which in turn drives wildlife out of the specific area in which said humans are attempting to encounter said wildlife. Thus, a human, using the present invention can urinate in the wilderness and still evade detection and/or attract/lure wildlife because wildlife's ability to smell human urine in the wilderness environment will be reduced, eliminated, and/or covered

To cover, eliminate and neutralize human urine scent in the wilderness is significant because hunters, wildlife enthusiast and photographers would be able to urinate in the wilderness without warning the wildlife around them as to their presence in the area and/or attract wildlife to the area. This also fills an unsolved need that hunters, wildlife enthusiasts and photographers have and helps them to have a more successful and enjoyable wilderness experience the results of which were not suggested or shown in prior art. The invention also provides advantages never before appreciated, such as comfort combined with stealth and human urine conversion to an attractant/lure in the wilderness. One would think that human urine scent cover, elimination and neutralization would be impossible in the wilderness environment, but is possible with new uses of existing products, the combination of existing products and new delivery methods of these products.

### SUMMARY

The primary objective of the present invention is to provide a means of being able to urinate in the wilderness without the urine scent being detected by the wildlife in a specific area.

Another objective of the present invention is to provide a means of luring and attracting wildlife into the specific area.

The present invention fulfils the above and other objects by providing four different semi-solid screen like wafers impregnated with either:

(a) odor elimination and neutralization product(s), including but not limited to scoe 10x, to eliminate and neutralize human urine scent in order to help evade detection by wildlife in the specific area,
(b) urine, glands and gland secretion from a selection of several different animals, including but not limited to deer, elk, fox, goat, skunk, or raccoon in order to help cover human urine scent to lure and attract wildlife into the specific area and to help evade detection by said wildlife.
(c) natural plant cover scents, from a selection of several different sources, including but not limited to, pine, cedar, acorn, apple and corn scents to order to help cover human urine scent to lure and attract wildlife into the specific area and to help evade detection by said wildlife. or
(d) any combination of the above three methods to eliminate and neutralize human urine scent and to help cover human urine scent to lure and attract wildlife into the specific area and to help evade detection by said wildlife. That can be placed on the ground and urinated on to dissolve said wafer(s) and thereby releasing the active ingredient(s) into the environment, producing the desired effect. A “scent bomb” is made. Or said wafer(s) can be broken into pieces and put in a container to collect urine and urinate into for later disposal.

### DRAWINGS

FIG. 1 is a perspective right-side view of the wafer constructed in accordance with the invention, showing the top of the wafer.

FIG. 2 is perspective view of the bottom of the wafer to show the stacking pin hole.

FIG. 3 is a lateral cross-sectional view of the wafer of FIGS. 1 & 2.

FIG. 4 is a lateral cross-sectional view of the wafers stacked together of FIGS. 1, 2 and 3.

### DETAILED DESCRIPTION OF THE PREFERRED EMBODIMENTS

While the present invention is satisfied by embodiments in a range of compositions, there will be described herein examples of the preferred embodiment of the invention, with the understanding that the present disclosure is to be considered as exemplary of the principals of the invention and is not intended to limit the invention to the embodiment described.

With the foregoing in mind, the preferred composition of matter of the present invention is as follows:

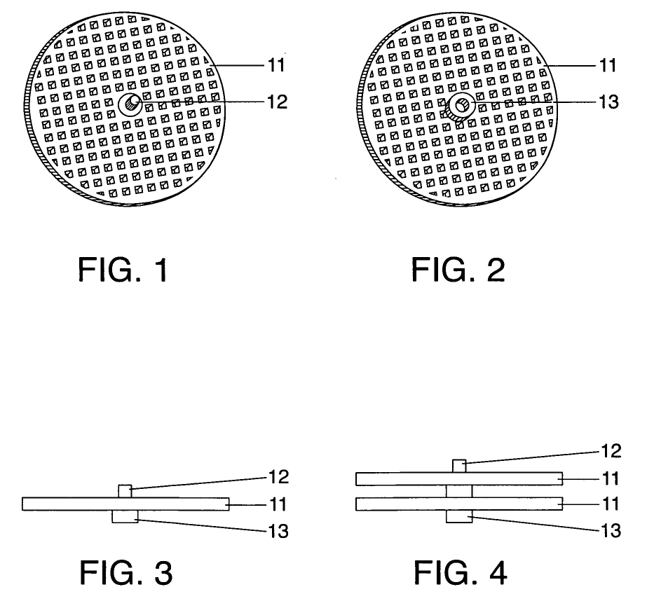

(a) to suspend any combination of urine odor elimination and neutralization products that are commercially readily available in a favourless gelatin base product that is commercially readily available, in a size and shape sufficient to hold and emit an amount of the active ingredient(s) effective to eliminate and neutralize human urine scent when urinated on. FIGS. 1, 2 & 3.
(b) to suspend any combination of animal urine scents, glands and gland secretions products that are commercially readily available, including but not limited to freeze dried products and natural liquid or solid state animal products, in a favourless gelatin base product that is commercially readily available in a size and shape sufficient to hold and emit an amount of the active ingredient(s) effective to lure and attract wildlife when urinated on. FIGS. 1, 2 & 3.
(c) to suspend any combination of natural cover scent products that are commercially readily available, including but not limited to freeze dried products and natural solid or liquid state products, in a favourless gelatin base product that is commercially readily available in a size and shape sufficient to hold and emit an amount of the active ingredient(s) effective to cover human urine scent when urinated on. FIGS. 1, 2 & 3.
(d) To combine any of the above three combinations using the same methods to create a fourth embodiment of composition, in a size and shape sufficient to hold and emit an amount of the active ingredients effective to eliminate and neutralize human urine scent, lure and attract wildlife, and/or cover human urine scent when urinated on. FIGS. 1, 2, 3 & 4.

A second composition to the preferred embodiment would be to suspend the active ingredient(s) found in the above four embodiments in a solid tablet form that would react with urine, fizzle and dissolve and thereby release the active ingredient(s) with the same effectiveness as the above embodiments.

The manufacture of the preferred embodiments are in the form of a flat round wafer, screened to allow urine to pass thru to create as large of a surface as possible to come in contact with the urine, in a semi-solid state, sealed in an airtight single use packet for ease of handling and to maintain the product, with the active ingredient(s) in a size to weight ratio determined in part by the manufacturer of the active ingredient(s) and in a size to weight ratio determined to be effective for its intended use.

The preferred embodiments once manufactured are then to functions as kits that contain all four different wafer embodiments and act as a human urine scent elimination and neutralization product, a lure and attractant product, a human urine scent cover product or a combination product.

Handling of the odor elimination and neutralization chemicals, animal urine, gland and gland secretion, and natural cover scents is greatly simplified by being in a pre-packaged, single use, airtight container as a semi-solid screen like wafer that dissolves on contract with urine.

It is understood that the forms of the invention described are preferred embodiments thereof and that the various changes and modifications may be made therein without departing from the spirit of the invention or the scope as defined in the following claims.

### REFERENCE NUMERALS

11 Semi-solid Wafer
12 Wafer stacking pin
13 Wafer stacking hole

### Operation

In operation, one uses the wafer(s) by opening the airtight packet containing said wafer(s) and places the wafer(s) on the ground in a wilderness environment and commences to urinate on the wafer(s) to dissolve the wafer(s), thereby releasing the active ingredient(s) from the wafer(s) into the environment to produce a scent bomb, scent elimination cloud or a combination thereof as indicated in the wafer packaging literature.

Another use of the wafer(s) would be to open the airtight packet containing said wafer and fold or brake the wafer(s) into quarters and place the wafer(s) into a container designed to hold urine and then commence to urinate into the container to dissolve the wafer(s) thereby releasing the active ingredient(s) from the wafer(s) into the environment to produce a scent bomb, scent elimination cloud, a combination thereof or assurance that the human urine scent emanating from the container has been covered, eliminated and neutralized as indicated in the wafer packaging literature.

1. A method for eliminating and neutralizing human urine scent comprising adding several different odor elimination and neutralization products to human urine in an amount effective to eliminate and neutralize human urine scent to lure and attract wildlife and evade detection.

2. The method of claim 1 wherein the product is packaged in a flat round wafer, screened, in a semi-solid gelatin material, with the active ingredient(s) in an effective size to weight ratio.

3. The method of claim 1 wherein the product is packaged in solid tablet form that would react with urine, fizzle and dissolve and thereby releasing the active ingredient(s).

4. A method for covering human urine scent comprising adding several different animal scent attractant products to human urine in an amount effective to cover human urine scent to lure and attract wildlife and evade detection.

5. The method of claim 4 using the same delivery system as in claim 2 and 3.

6. A method for covering human urine scent comprising adding several different natural cover scent products to human urine in an amount effective to cover human urine scent to lure and attract wildlife and evade detection.

7. The method of claim 6 using the same delivery system as in claim 2 and 3.

8. A method of combining claim 1, 4 and 6 to eliminate and neutralize human urine scent, to cover human urine scent to lure and attract wildlife and evade detection.

9. The method of claim 8 using the same delivery system as in claim 2 and 3. In addition, stacking said wafers with each wafer having one of the characteristics of claim 1, 4 and 6.
